(19) United States
(12) Patent Application Publication
(10) Pub. No.: US 2012/0066525 A1
(43) Pub. Date: Mar. 15, 2012

(54) COMMUNICATION DEVICE AND METHOD FOR CONTROLLING SAME

(75) Inventors: Nobuhiro TAMURA, Nagoya-shi (JP); Hiroshi NAKATAKE, Nagoya-shi (JP)

(73) Assignee: Buffalo Inc., Nagoya-shi (JP)

(21) Appl. No.: 13/227,988

(22) Filed: Sep. 8, 2011

(30) Foreign Application Priority Data
Sep. 9, 2010 (JP) 2010-201898

(51) Int. Cl. G06F 1/26

(52) U.S. Cl. 713/310

(57) ABSTRACT

The rotating speed of a cooling fan is controlled in accordance with the number of devices connected to ports of a packet transmitting/receiving unit and a connection speed with that device. When the number of ports establishing a link at a speed of 1 Gbps is zero, the voltage value of power output from a power source block to the cooling fan is 0 V and the cooling fan is deactivated. When the number of ports establishing a link at a speed of 1 Gbps is one or two, the voltage value is 8 V and the cooling fan rotates in a slow mode. Furthermore, when the number of ports establishing a link at a speed of 1 Gbps is three or four, the voltage value is 12 V and the cooling fan rotates in a fast mode.

### CROSS-REFERENCE TO RELATED APPLICATION

This application claims the benefit of Japanese Patent Application No. 2010-201898 filed on Sep. 9, 2010, the entire disclosure of which is incorporated herein by reference.

### BACKGROUND OF THE INVENTION

1. Field of the Invention

The present invention relates to a communication device, and more particularly, a communication device and a method of controlling the same which suppress an internal temperature of a device to be equal to or lower than a certain temperature.

2. Description of the Related Art

Communication devices, such as a switching hub and a router, are used in order to establish a wired network or a wireless network. Recently, a fast-speed wired network using a protocol like 10 gigabit Ethernet (registered trademark) or 1 gigabit Ethernet (registered trademark), and a fast-speed wireless network using a protocol like IEEE (The Institute of Electrical and Electronics Engineers) 802.11n are in practical use. Together with the increase of the load originating from the speed-up of such networks, cooling of a communication device becomes a technical issue.

In general, in an electronic device using semiconductor devices like a personal computer or a communication device, in order to suppress a failure like thermal runaway originating from a temperature rise in the electronic device due to heat generated by the semiconductor devices, a cooling fan is used which cools down the interior of the electronic device. Moreover, a technology is known which detects the internal temperature of an electronic device, and which controls the rotating speed of a cooling fan in accordance with the detected temperature, thereby reducing power consumption and noises from the cooling fan and thus making the cooling fan long-life. In order to detect the internal temperature of the electronic device and to keep the internal temperature of the electronic device to be a constant temperature, a temperature detecting element and an exclusive micro computer are necessary (see, for example, JP 2006-196499 A).

According to such a related art, however, it is necessary to put the temperature detecting element inside the electronic device. Moreover, depending on the location of the temperature detecting element inside the electronic device, a temperature of a portion of the interior of the device that needs cooling and a detected temperature do not match in some cases.

The present invention has been made in view of the above-explained circumstance, and it is an object of the present invention to provide a communication device and a method for controlling the same which are capable of controlling a cooling fan without a temperature detecting element and which can maintain the internal temperature of the electronic device to be equal to or lower than constant.

### SUMMARY OF THE INVENTION

A communication device of the present invention that relays packets in a communication system includes: a packet transmitting/receiving unit that transmits/receives packets; a use-rate detecting unit that detects a use rate of the packet transmitting/receiving unit; a cooling fan that rotates at a rotation speed in accordance with a supplied output voltage value in order to cool the communication device; a power source unit that supplies power to the cooling fan at a predetermined output voltage value; and a voltage control unit that controls the output voltage value output by the power source unit based on a use rate of the packet transmitting/receiving unit detected by the use-rate detecting unit.

The packet transmitting/receiving unit may include a wired-connection unit that is connected to a terminal of the communication system through a cable. In this case, the use-rate detecting unit detects a use rate of the packet transmitting/receiving unit in accordance with the number of terminals connected with the wired-connection unit and a connection speed with the terminal.

The packet transmitting/receiving unit may include a wireless-connection unit that is wirelessly connected to a terminal of the communication system. In this case, the use-rate detecting unit detects a use rate of the packet transmitting/receiving unit in accordance with a use rate of a transmitter amplifier included in the wireless-connection unit.

The cooling fan may be detachable from the communication device, and the communication device may further include a fan detecting unit detecting whether or not the cooling fan is attached to the communication device. When the fan detecting unit detects that no cooling fan is attached, the communication device restricts an operation of the packet transmitting/receiving unit.

The voltage control unit may control the output voltage value so that the higher the use rate of the packet transmitting/receiving unit detected by the use-rate detecting unit is, the faster the rotation speed of the cooling fan becomes.

According to the present invention, a correspondence relationship between the use rate of the packet transmitting/receiving unit and the rotating speed of the cooling fan is set beforehand, and a control is performed based on such a correspondence relationship. This makes it possible to reduce the internal temperature of the communication device to be equal to or lower than a certain temperature without causing the cooling fan to rotate excessively and without the need of a temperature detecting element.

A control method of the present invention is for a communication device which relays packets in a communication system and which includes a packet transmitting/receiving unit that transmits/receives packets, and a cooling fan that rotates at a rotation speed in accordance with a supplied output voltage value in order to cool the communication device, and the control method includes the steps of: causing the packet transmitting/receiving unit to transmit/receive packets; detecting a use rate of the packet transmitting/receiving unit; and supplying power to the cooling fan at an output voltage value in accordance with the detected use rate.

The present invention can be embedded in various forms, and for example, the present invention can be realized in the form of a computer program for a communication device and for realizing a control method of the same, or of a recording medium storing such a computer program.

### BRIEF DESCRIPTION OF THE DRAWINGS

FIG. 1 is a hardware configuration diagram showing a communication device according to a first embodiment of the present invention;

FIG. 2 is a flowchart showing an operation of the communication device according to the first embodiment;

FIG. 3 is a diagram showing an illustrative state of a cooling fan according to the first embodiment;

FIG. 4 is a diagram showing a state transition of the communication device according to the first embodiment;

FIG. 5 is a hardware configuration diagram showing a wireless packet transmitting/receiving unit of a communication device according to a second embodiment of the present invention;

FIG. 6 is a flowchart showing an operation of the communication device according to the second embodiment;

FIG. 7 is a diagram showing an illustrative state of a cooling fan according to the second embodiment; and

FIG. 8 is a diagram showing a state transition of the communication device according to the second embodiment.

### DETAILED DESCRIPTION OF THE PREFERRED EMBODIMENTS

A detailed explanation will be given of embodiments of the present invention with reference to the accompanying drawings.

### First Embodiment

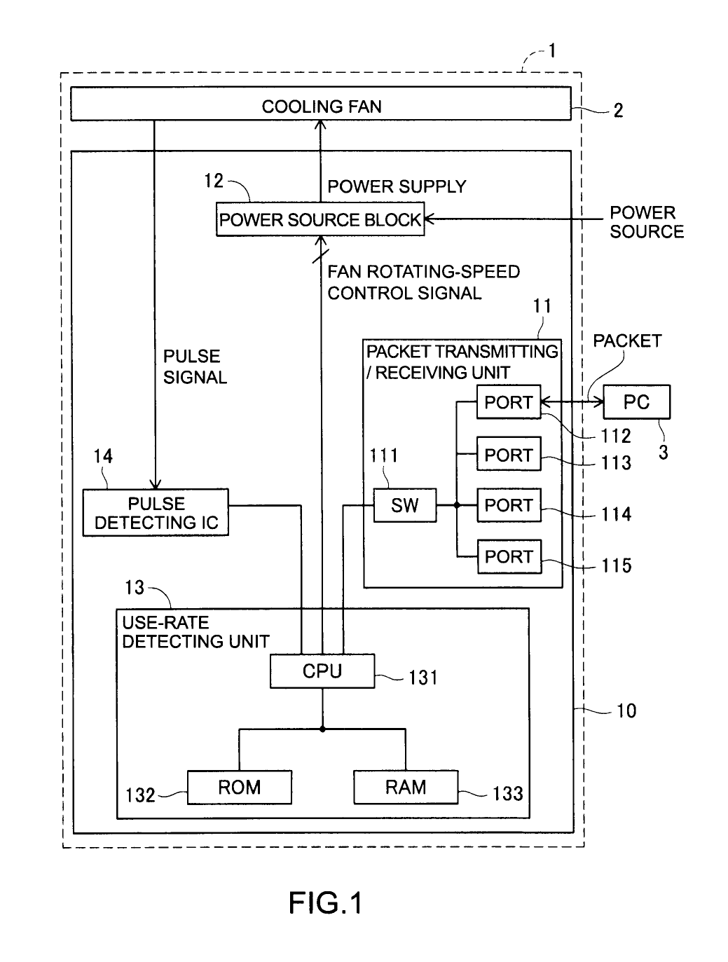

FIG. 1 is a hardware configuration diagram showing a communication device 1 according to a first embodiment of the present invention. The communication device 1 of the present embodiment includes a communication unit 10 and a cooling fan 2. The communication unit 10 includes a packet transmitting/receiving unit 11, a power source block 12, a use-rate detecting unit 13, and a pulse detecting IC 14. The cooling fan 2 is detachable from the communication unit 10, and is used for cooling the communication unit 10.

The packet transmitting/receiving unit 11 transmits/receives (exchanges), using packets, information with one or a plurality of devices present outside the communication device 1 and having a communication function. The packet transmitting/receiving unit 11 of the present embodiment includes a switching element 111 and ports 112 to 115. The ports 112 to 115 are wired to devices present at the outside location. The switching element 111 receives packets through any one of the ports 112 to 115 from devices like a personal computer (hereinafter, referred to as a PC) 3 present outside the communication device 1. Moreover, the switching element 111 transfers packets through any one of the ports 112 to 115 to the device present outside the communication device 1 using information included in the packets. In the present embodiment, the number of ports of the communication device 1 is four, but it should be understood that the number of the ports can be naturally changed to an arbitrary number.

The switching element 111 changes the transfer rate of packets depending on the device connected to any one of the ports 112 to 115. The switching element 111 is an element that has, for example, a layer-2 switching function, a layer-3 switching function, or a router function. The switching element 111 is connected to the device present outside the communication device 1 at a speed of for example, 10 Gbps (Giga bit per second), 1 Gbps, 100 Mbps (Mega bit per second), or 10 Mbps depending on the state of that device. The connection speed between the switching element 111 and the device is set when the switching element 111 is connected to the device and a link therebetween is established.

In the present embodiment, the switching element 111 establishes a link with an external device through any one of the ports 112 to 115 at a connection speed of 1 Gbps or equal to or slower than 100 Mbps. When the switching element 111 is connected to the external device at the speed of 1 Gbps, in comparison with a connection at the speed of equal to or slower than 100 Mbps, the process load originating from the exchange of the packets increases, resulting in the increase of the amount of heat generation by the packet transmitting/receiving unit 11. In the present embodiment, in order to cool such heat generation by the packet transmitting/receiving unit 11, the rotating speed of the cooling fan 2 is increased or decreased in accordance with the number of ports which establish links with respective external devices at the speed of 1 Gbps.

Power is supplied to the power source block (a power source unit) 12 from a power source present outside the communication device 1. The power source block 12 supplies power to the communication unit 10 and the cooling fan 2 based on the power supplied from the exterior. The power source block 12 outputs power to the cooling fan 2 at a predetermined voltage value in accordance with a fan rotating-speed control signal output by the use-rate detecting unit 13 to be discussed later, and the cooling fan 2 rotates at a predetermined rotating speed in accordance with the voltage value.

The use-rate detecting unit 13 includes a CPU 131, a ROM 132, and a RAM 133. The CPU 131 controls the switching element 111, and monitors the packet transmitting/receiving unit 11 to control the power source block 12. The ROM 132 stores a firmware for an operation of the communication device 1, and setting used for a control like information that associates the use rate of the packet transmitting/receiving unit 11 with the rotating speed of the cooling fan 2. The RAM 132 is used as a memory area for allowing the CPU 131 to perform arithmetic processing. The CPU 131 of the use-rate detecting unit 13 is connected to the switching element 111 of the packet transmitting/receiving unit 11, and detects the use rate of the packet transmitting/receiving unit 11. In the present embodiment, the use rate of the packet transmitting/receiving unit 11 detected by the use-rate detecting unit 13 is set based on the number of devices connected to respective ports of the packet transmitting/receiving unit 11 and the connection speed with each device. More specifically, the use rate is defined as a ratio of the number of all ports of the packet transmitting/receiving unit 11 and the number of ports 112 to 115 which establish respective links at the connection speed of 1 Gbps. A fan rotating-speed control signal is output to the power source block 12 based on the use rate of the packet transmitting/receiving unit 11 detected in this fashion. The power source block 12 outputs power to the cooling fan 2 at a predetermined output voltage value in accordance with the fan rotating-speed control signal. Thus, the cooling fan 2 rotates at a predetermined rotating speed. Hence, the use-rate detecting unit 13 also serves as a voltage controller that controls the output voltage value output by the power source block 2 in accordance with the use rate of the packet transmitting/receiving unit 11. A control operation of the rotating speed of the cooling fan 2 is thus enabled by respective operations of the packet transmitting/receiving unit 11, the power source block 12, and the use-rate detecting unit 13 in accordance with the use rate of the packet transmitting/receiving unit 11.

When power is being supplied to the cooling fan 2 and the cooling fan 2 is rotating, the cooling fan 2 inputs a pulse signal to the pulse detecting IC 14. The pulse signal is output every time the cooling fan 2 rotates by a certain number. The pulse detecting IC 14 detects the rotating speed of the cooling fan 2 based on the input frequency of the pulse signal, and notifies the CPU 131 of the detected rotating speed. Moreover, the pulse detecting IC 14 notifies the CPU 131 of the use-rate detecting unit 13 of inputting of the pulse signal from the cooling fan 2. Based on the operation by the pulse detecting IC 14, it becomes possible to detect whether or not the cooling fan 2 is connected to the communication unit 10.

When the cooling fan 2 is not connected to the communication unit 10, the CPU 131 controls the packet transmitting/receiving unit 11 in order to cause the communication device 1 to operate in a restriction mode having a communication function restricted. In the restriction mode of the present embodiment, for example, a connection at the speed of 1 Gbps is prohibited for all ports of the packet transmitting/receiving unit 11, and a link at a speed of equal to or slower than 100 Mbps is forcibly established. Accordingly, when the cooling fan 2 is not attached, heat generation by the packet transmitting/receiving unit 11 is suppressed, which prevents the packet transmitting/receiving unit 11 from operating abnormally like thermal runaway.

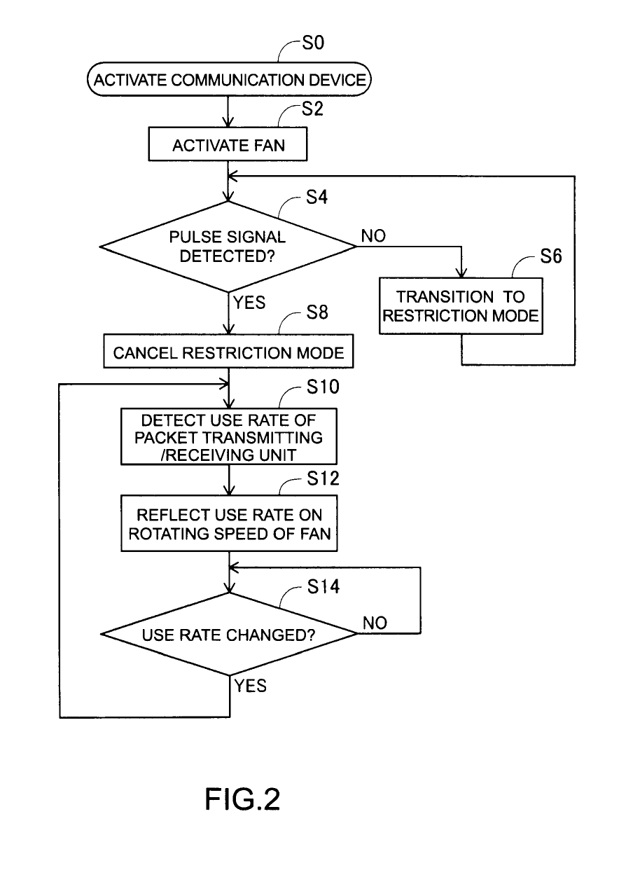

An operation of the communication device 1 of the present embodiment will be shown in a flowchart of FIG. 2. In a step S0, power is supplied to the communication device 1 from an external power source, and the communication device 1 is activated. Following the step S0, power is supplied to the cooling fan 2 from the power source block 12, and the cooling fan 2 is activated (step S2). Next, it is detected whether or not a pulse signal is input into the pulse detecting IC 14 from the cooling fan 2 (step S4). When no pulse signal is detected, i.e., when the cooling fan 2 is not connected to the communication unit 10 (step S4: NO), the communication device 1 transitions the state to the restriction mode (step S6). When the communication device 1 is set to be in the restriction mode, it is detected again whether or not a pulse signal is input (step S4).

When the pulse signal is detected, i.e., when the cooling fan 2 is connected to the communication unit 10 (step S4: YES), and when the communication device 1 is set to be in the restriction mode, the restriction mode is cancelled (step S8). Next, the use-rate detecting unit 13 detects the use rate of the packet transmitting/receiving unit 11 (step S10). Information relating to the correspondence relationship between the use rate of the packet transmitting/receiving unit 11 and the rotating speed of the cooling fan 2 is stored in the ROM 132. Based on the stored information, the CPU 131 outputs the fan rotating-speed control signal to the power source block 12 so that the rotating speed of the cooling fan 2 becomes a rotating speed in accordance with the use rate of the packet transmitting/receiving unit 11 detected in the step S10. The power source block 12 supplies power to the cooling fan 2 at a voltage value in accordance with the input fan rotating-speed control signal. Consequently, the cooling fan 2 rotates at a rotating speed in accordance with the use rate of the packet transmitting/receiving unit 11 (step S12). When the use-rate detecting unit 13 detects no change in the use rate of the packet transmitting/receiving unit 11 (step S14: NO), the cooling fan 2 keeps rotating at the rotating speed set in the step S12. When a change in the use rate of the packet transmitting/receiving unit 11 is detected (step S14: YES), the process transitions to the step S10 and the rotating speed of the cooling fan 2 is set again.

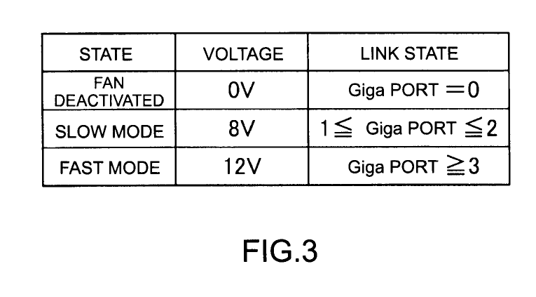

FIG. 3 shows an illustrative correspondence relationship among a link state that indicates the use rate of the packet transmitting/receiving unit 11, a state of the cooling fan 2 corresponding to the link state, and a voltage value output from the power source block 12 to the cooling fan 2. The correspondence relationship between the use rate of the packet transmitting/receiving unit 11 and the rotating speed of the cooling fan 2 is set so that the internal temperature of the communication device 1 is reduced to equal to or lower than a certain temperature no matter what use rate the packet transmitting/receiving unit 11 is by actually causing the communication device 1 to operate beforehand and by collecting data thereof. Moreover, information on such a correspondence relationship is stored in the ROM 132 of the use-rate detecting unit 13. Information on the correspondence relationship may be calculated and set based on a numerical processing like a simulation, a set value on a device designing, or various parameters in the use environment of the communication device 1 in use in addition to the collection of data through an actual operation.

Next, an operation of the communication device 1 based on the correspondence relationship shown in FIG. 3 will be explained. When the number of ports among the ports 112 to 115 of the packet transmitting/receiving unit 11 establishing a link at a speed of 1 Gbps is zero, the voltage value of the power output from the power source block 12 to the cooling fan 2 is 0 V, and the cooling fan 2 stops operating. When the number of ports establishing a link at a speed of 1 Gbps is one or two, the voltage value of the power output from the power source block 12 to the cooling fan 2 is 8 V, and the cooling fan 2 rotates in a slow mode. When the number of ports establishing a link at a speed of 1 Gbps is three or four, the voltage value of the power output from the power source block 12 to the cooling fan 2 is 12 V, and the cooling fan 2 rotates in a fast mode.

An example input voltage value to the cooling fan 2 in the slow mode and an example rotating speed of the cooling fan 2 are 8 V of an input voltage value and 3000 rpm of the rotating speed. Note that rpm is a unit indicating a rotating speed per one minute, which is an abbreviation of revolutions per minute. Moreover, examples of the input voltage value to the cooling fan 2 and the rotating speed of the cooling fan 2 in the fast mode are 12 V of the input voltage value and 4500 rpm of the rotating speed.

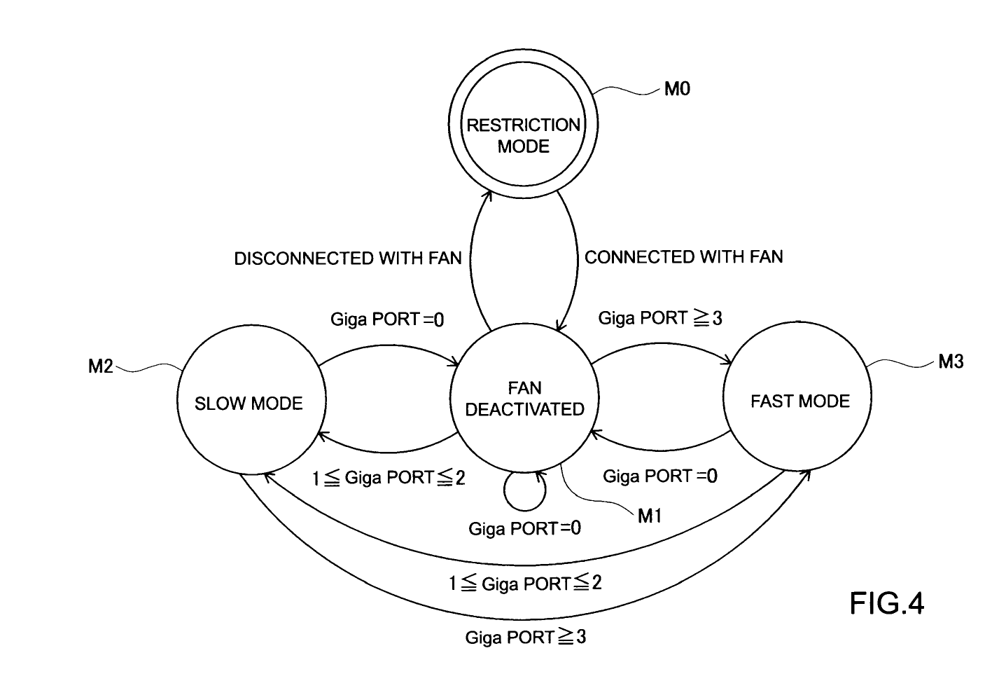

A state transition of the communication device 1 of the present embodiment is shown in FIG. 4. When the communication speed of all ports that are four ports of the packet transmitting/receiving unit 11 is equal to or slower than 1 Gbps, the heat generation amount by the whole communication device 1 is little. In this case, the power source block 12 of the communication device 1 stops supplying power to the cooling fan 2, and the communication device 1 becomes a fan stopping state M1. In the fan stopping state M1, when a connection between the communication unit 10 and the cooling fan 2 is disconnected, the state transitions to a restriction mode M0. In the restriction mode M0, when the cooling fan 2 is connected to the communication unit 10, the state transitions to a fan stopping state M1 again.

In the fan stopping state M0, when the communication speed of all of the four ports of the packet transmitting/receiving unit 11 is equal to or slower than 1 Gbps, no state transition occurs and the state is still the fan stopping state M0. In the fan stopping state M0, when the communication speed of one or two ports establishing a connection with an external device becomes 1 Gbps, the state transitions to a slow mode M2 in which the cooling fan 2 rotates at a slow speed. Moreover, in the fan stopping state M0, when the communication speed of three or four ports establishing a connection with an external device becomes 1 Gbps, the state transitions to a fast mode M3 in which the cooling fan rotates at a fast speed in comparison with the slow mode.

In the slow mode M2, when the communication speed of all of the four ports establishing a connection with an external device becomes equal to or slower than 1 Gbps, the state transitions to the fan stopping state M1. Moreover, in the slow mode M2, when the communication speed of the three or four ports establishing a connection with an external device becomes 1 Gbps, the state transitions to the fast mode M3. In the fast mode M3, when the communication speed of all of the four ports establishing a connection with an external device becomes equal to or slower than 1 Gbps, the state transitions to the fan stopping mode M0. Moreover, in the fast mode M3, when the communication speed of only one or two ports establishing a connection with an external device becomes 1 Gbps, the state transitions to the slow mode M2.

As explained above, according to the present embodiment, the rotating speed of the cooling fan 2 is controlled in accordance with the number of external devices connected to the ports 112 to 115 of the packet transmitting/receiving unit 11 of the communication device 1, and the connection speed established with that external device. The heat generation amount by the packet transmitting/receiving unit 11 largely varies depending on the number of ports establishing a link with an external device at a fast connection speed like 1 Gbps, so that the rotating speed of the cooling fan 2 can be appropriately controlled and thus the internal temperature of the communication device 1 can be controlled to be equal to or lower than a certain temperature. Moreover, such a temperature control can be carried out without providing an element for temperature detection in the communication device 1.

Furthermore, according to the present embodiment, when the cooling fan 2 is not connected to the communication unit, the state transitions to the restriction mode. Accordingly, heat generation originating from the process executed by the packet transmitting/receiving unit 11 can be reduced, and a failure inherent to the temperature rise can be suppressed.

### Second Embodiment

A communication device according to a second embodiment of the present invention has a communication unit that has a wireless packet transmitting/receiving unit 11B which transmits/receives packets through a wireless communication with an external device and which is replaced with the packet transmitting/receiving unit 11 of the communication unit 10 of the first embodiment. Regarding the other configuration, the communication device has the same configuration as that of the communication device 1 (see FIG. 1) of the first embodiment. In the following explanation, the same component will be denoted by the same reference numeral as that of the communication device 1 of the first embodiment, and the duplicated explanation will be simplified.

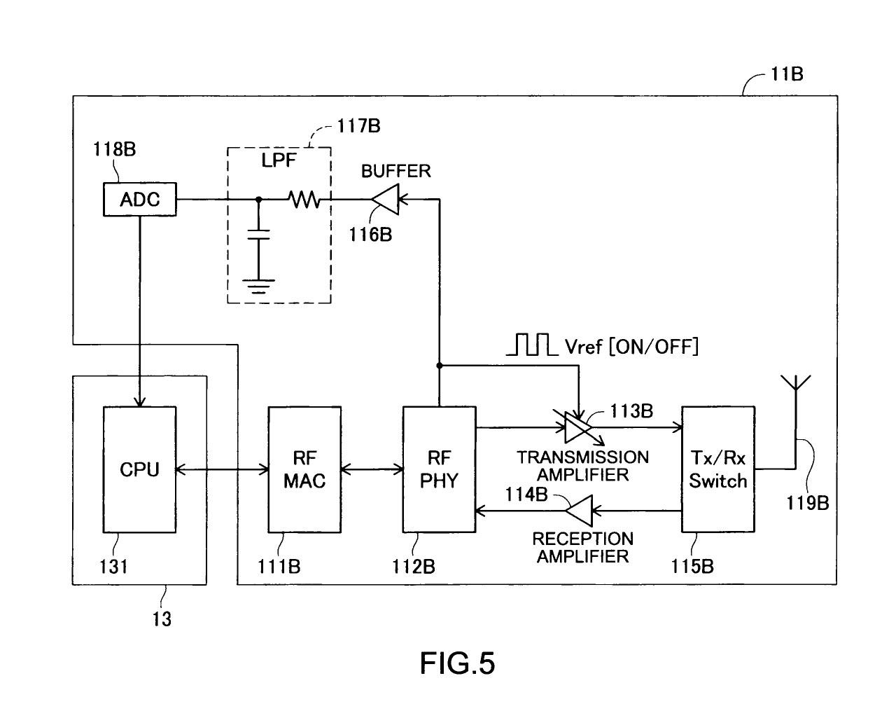

FIG. 5 shows a wireless packet transmitting/receiving unit 11B of the communication device 1 of the second embodiment. The wireless packet transmitting/receiving unit 11B includes an RF MAC (Radio Frequency Media Access Control) element 111B, an RF PHY (Radio Frequency Physical Layer) element 112B, a transmission amplifier 113B, a reception amplifier 114B, a Tx/Rx (Transmitter/Receiver) switch 115B, a buffer 116B, a low-pass filter 117B, an analog/digital converter 118B, and an antenna 119B.

The RF MAC element 111B is controlled by the CPU 131, performs a digital baseband processing among the processes relating to the transmission/reception of packets over a wireless network, and transmits/receives a signal with the RF PHY element 112B. The RF PHY element 112B performs a conversion process from/to a logic signal and to/from an analog signal between the RF MAC element 111B and the antenna 119B.

The transmission amplifier 113B is a power amplifier circuit which amplifies a signal input from the RF PHY element 112B, and which outputs an amplified signal to the antenna 119B through the Tx/Rx switch 115B. When a reference voltage signal Vref output by the RF PHY element 112B is high level, the transmission amplifier 113B becomes an on state and when it is low level, the transmission amplifier 113B becomes an off state. When the communication device transmits packets to an external device, the transmission amplifier 113B becomes an on state.

In the communication device 1 of the second embodiment, the power consumption by the transmission amplifier 113B is the highest. Accordingly, by measuring a rate how much time the transmission amplifier 113B is in an on state per a unit time, i.e., by measuring the use rate of the transmission amplifier 113B, it is possible to detect a heat generation amount of the communication device per a unit time. In order to measure a time at which the transmission amplifier 113B is in an on state per a unit time, it is appropriate to measure a time at which the reference voltage signal Vref is high level. A rate of Vref being high level per a unit time is referred to as a Vref load rate. For example, when the Vref load rate is 100%, it means that in a measured unit time, the transmission amplifier 113B is always in an on state. Moreover, when the Vref load rate is 10%, it means that the transmission amplifier 113B is in an on state by 10% of the measured unit time. In the present embodiment, the Vref load rate, i.e., the use rate of the transmission amplifier 113B of the communication device 1 is defined as the use rate of the wireless packet transmitting/receiving unit 11B.

In order to improve the throughput of a wireless communication, a plurality of paths and a plurality of transmission amplifiers 113B may be provided between the RF PHY element 112B and the Tx/Rx switch 115B, and electromagnetic waves at different frequencies may be transmitted to external devices through the antenna 119B. In this case, an average value of the Vref load rates of all transmission amplifiers 113B of the communication device is defined as the use rate of the wireless packet transmitting/receiving unit 11B.

The reception amplifier 114B is a low-noise amplifier circuit that inputs a signal received by the antenna 119B into the RF PHY element 112B through the Tx/Rx switch 115B. The Tx/Rx switch 115B is a switch circuit that connects the reception amplifier 114B when the wireless packet transmitting/receiving unit 11B is in a packet receiving state (Rx) or the transmission amplifier 113B when it is in a packet transmitting state (Tx) to the antenna 119B.

The buffer 116B, the low-pass filter 117B, and the analog/digital converter 118B are used for measuring the Vref load rate. Input into the buffer 116B is the reference voltage signal Vref that is used by the RF PHY element 112B to control the on/off state of the transmission amplifier 113B. The buffer 116B outputs the reference voltage signal Vref to the low-pass filter 117B for a certain time in order to measure the Vref load rate. The low-pass filter 117B serves as an RC integration circuit which outputs, into the analog/digital converter 118B, a time integral of the reference voltage signal Vref input from the buffer 116B. The analog/digital converter 118B converts a voltage value indicating the time integral of the input reference voltage signal Vref, i.e., the Vref load rate into a digital signal, and outputs the converted digital signal to the CPU 131 of the use-rate detecting unit 13. In order to measure the Vref load rate, it is appropriate to measure a time integral of the reference voltage Vref per unit time. Accordingly, it is needless to say that the buffer 116B, the low-pass filter 117B, and the analog-digital converter 118B may be replaced with other circuits having a time integral function.

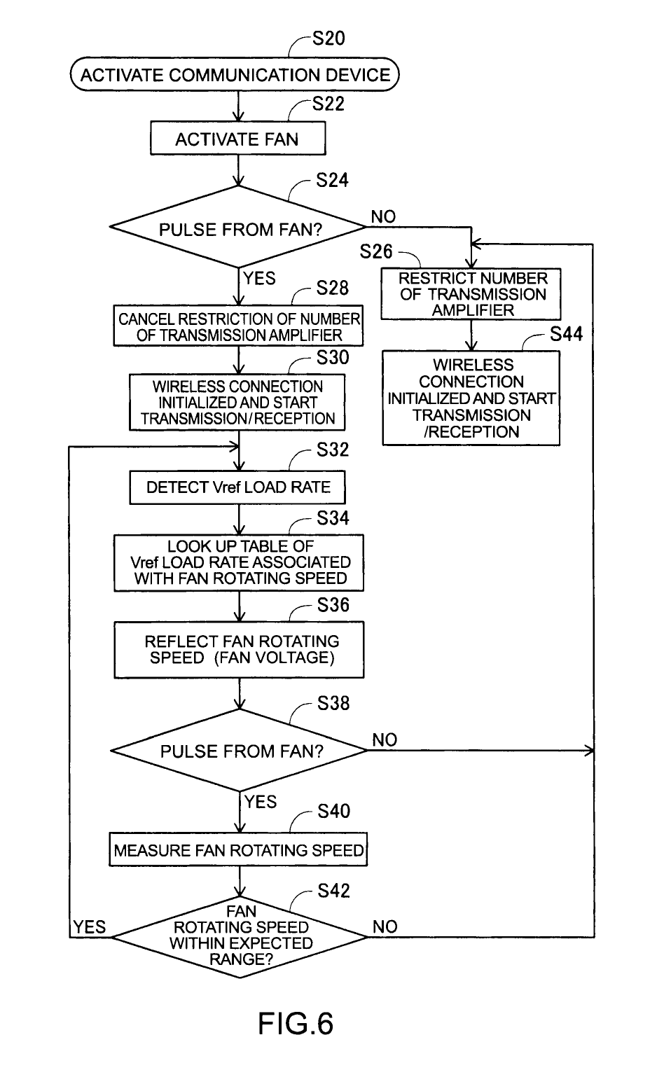

An operation of the communication device 1 of the present embodiment will be shown in a flowchart of FIG. 6. In a step S20, the communication device is activated. Next, power is supplied to the cooling fan 2 from the power source block 12, and the cooling fan 2 is instructed to start rotating (step S22). Next, it is detected whether or not a pulse signal which is a notification of a connection of the cooling fan 2 to the communication unit 10 is output into the pulse detecting IC 14 from the cooling fan 2 (step S24). Thereafter, when no pulse signal is output by the cooling fan 2 (step S24: NO), and when the communication device has a plurality of transmission amplifiers 113B, the number of transmission amplifiers 113B to be activated is restricted (step S26). The communication device 1 is then initialized and the wireless packet transmitting/receiving unit 11B starts transmitting/receiving packets (step S44).

In the step S24, when the cooling fan 2 outputs the pulse signal to the pulse detecting IC 14 (step S24: YES), and when the number of operable transmission amplifiers 113B is restricted, such a restriction is cancelled (step S28). Next, the communication device 1 is initialized and transmission/reception of packets starts (step S30). Thereafter, the Vref load rate is detected (step S32). Next, a correspondence relationship between the Vref load rate stored in the ROM 132 and the rotating speed of the cooling fan 2 is looked up (step S34). The rotating speed of the cooling fan 2 is thus changed in accordance with the detected Vref load rate and that correspondence relationship (step S36).

Next, it is determined whether or not a pulse signal is input into the pulse detecting IC 14 from the cooling fan 2 (step S38). When no pulse signal is input into the pulse detecting IC 14 from the cooling fan 2, i.e., when the cooling fan 2 is not connected to the communication unit (step S38: NO), the process transitions to the step S26. When the pulse signal is input into the pulse detecting IC 14 from the cooling fan 2 (step S38: YES), the rotating speed of the cooling fan 2 is measured based on the pulse signal (step S40). It is detected whether or not the rotating speed of the cooling fan 2 is within an expected range (step S42). When the rotating speed of the cooling fan 2 is out of the expected range (step S42: NO), the process transitions to the step S26. When the rotating speed of the cooling fan 2 is within the expected range, the process transitions to the step S32, and the Vref load rate is detected at a certain cycle of a time.

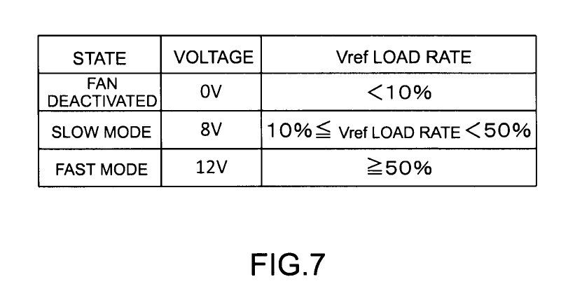

FIG. 7 shows an illustrative correspondence relationship among the Vref load rate that is the use rate of the wireless packet transmitting/receiving unit 11B, a state of the cooling fan 2 corresponding to the Vref load rate, and a voltage value output from the power source block 12 to the cooling fan 2. The correspondence relationship between the Vref load rate of the wireless packet transmitting/receiving unit 11B and the rotating speed of the cooling fan 2 is set by collecting data on the communication device 1 actually operated so that the internal temperature of the communication device 1 is suppressed to be equal to or lower than a certain temperature and thus no failure occurs regardless of the value of the Vref load rate. Information on the correspondence relationship is stored in the ROM 132 of the use-rate detecting unit 13. Information on the correspondence relationship may be calculated and set based on a numeric processing like a simulation, a set value on the device design, or various parameters of the use environment of the communication device 1 in use.

An explanation will be given of an operation of the communication device 1 based on the correspondence relationship shown in FIG. 7. When the Vref load rate of the wireless packet transmitting/receiving unit 11B becomes less than 10%, the voltage value of power output from the power source block 12 to the cooling fan 2 is 0 V, so that the cooling fan 2 is deactivated. When the Vref load rate is equal to or higher than 10% and less than 50%, the voltage value of power output to the cooling fan 2 from the power source block 12 is 8 V, and the cooling fan 2 rotates in a slow mode. When the Vref load rate is equal to or higher than 50%, the voltage value of power output to the cooling fan 2 from the power source block 12 is 12 V, and the cooling fan 2 rotates in a fast mode. The relationship between the voltage value and the rotating speed of the cooling fan in each mode is same as that of the first embodiment.

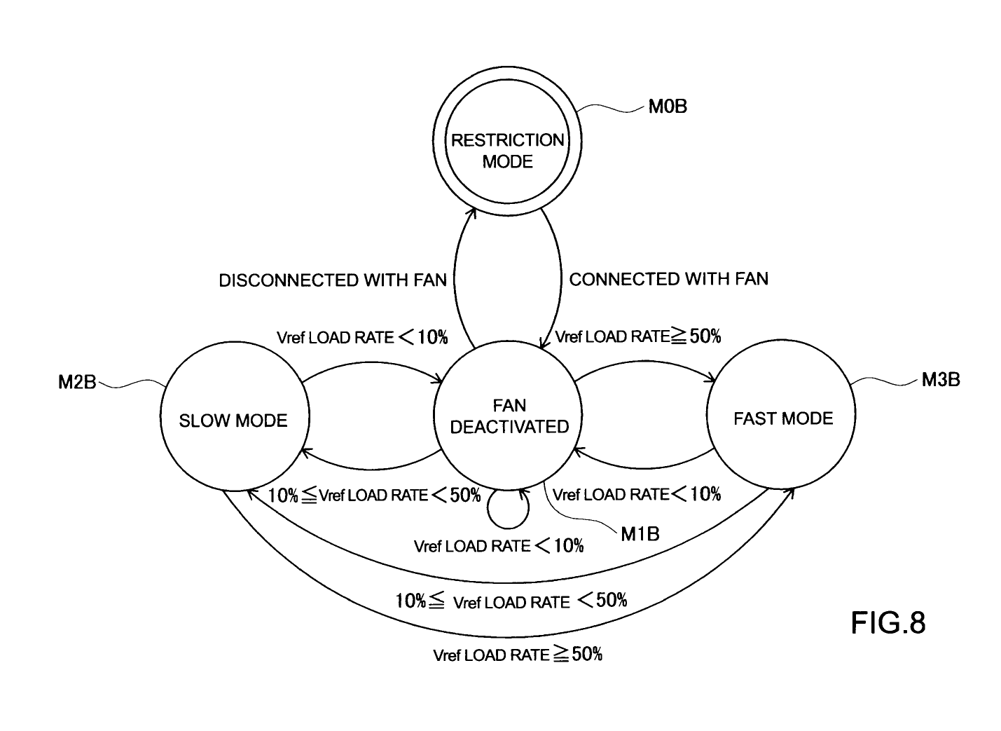

FIG. 8 shows a state transition of the communication device according to the present embodiment. The communication device of the present invention is in, at the time of activation of the device, a fan deactivated state M1B in which the cooling fan 2 stops rotating. By disconnecting the connection between the cooling fan 2 and the communication unit 10, the state transitions to a restriction mode M0B. In the restriction mode M0B, by connecting the cooling fan 2 and the communication unit 10, the state transitions to a fan deactivated state M1B.

In the fan deactivated state M1B, when the cooling fan 2 and the communication unit 10 are not disconnected and when the Vref load rate is less than 10%, no state transition occurs. In the fan deactivated state M1B, when the Vref load rate becomes equal to or higher than 10% and less than 50%, the state transitions to a slow mode M2B in which the cooling fan 2 rotates at a slow speed. In the fan deactivated state M1B, when the Vref load rate becomes equal to or higher than 50%, the state transitions to a fast mode M3B in which the cooling fan 2 rotates at a fast speed.

In the slow mode M2B, when the Vref load rate becomes less than 10%, the state transitions to the fan deactivated state M1B. Moreover, in the slow mode M2B, when the Vref load rate becomes equal to or higher than 50%, the state transitions to the fast mode M3B. In the fast mode M3B, when the Vref load rate becomes less than 10%, the state transitions to the fan deactivated state M1B. Moreover, in the fast mode M3B, when the Vref load rate becomes equal to or higher than 10% and less than 50%, the state transitions to the slow mode M2B.

As explained above, according to the present embodiment, the use rate of the wireless packet transmitting/receiving unit 11B is defined on the basis of the Vref load rate, i.e., a time at which the transmission amplifier 113B of the wireless packet transmitting/receiving unit 11B of the communication device 1 is in an on state per a unit time. Next, based on the use rate, the rotating speed of the cooling fan 2 is controlled. The heat generation amount by the wireless packet transmitting/receiving unit 11B largely varies depending on a time at which the transmission amplifier 113B is in an on state, the rotating speed of the cooling fan 2 is appropriately controlled and thus the internal temperature of the communication device 1 can be controlled to be equal to or lower than a certain temperature. In addition, such a temperature control can be carried out without a temperature detecting element provided in the communication device 1.

Moreover, according to the present embodiment, when the cooling fan 2 is not connected to the communication unit 10, the state transitions to the restriction mode. Accordingly, heat generation originating from a process executed by the wireless packet transmitting/receiving unit 11B is reduced, and thus a failure inherent to a temperature rise can be prevented.

The present invention is not limited to the above-explained embodiments, and can be changed and modified in various forms within the scope and spirit of the present invention. For example, the communication device may include both the packet transmitting/receiving unit 11 of the first embodiment and wireless packet transmitting/receiving unit 11B of the second embodiment. In this case, the rotating speed of the cooling fan 2 can be set based on the use rate of the packet transmitting/receiving unit 11 and the use rate of the wireless packet transmitting/receiving unit 11B.

In the above-explained first and second embodiments, there are four states: the restriction mode M0B; the fan deactivated mode M1B; the slow mode M2B; and the fast mode M3B. However, it is needless to say that a further state for further controlling the rotating speed of the cooling fan step by step can be added. Furthermore, it is possible to increase the rotating speed of the cooling fan 2 in a stepless manner in proportional to the increase of the use rate (the Vref load rate) of the packet transmitting/receiving unit 11 or the wireless packet transmitting/receiving unit 11B. In this case, step-by-step mode becomes unnecessary.

The ports 112 to 115 in the first embodiment are example wired-connection units. Moreover, the RF MAC element 111B, the RF PHY element 112B, the transmission amplifier 113B, the reception amplifier 114B, the Tx/Rx switch 115B, and the antenna 119B in the second embodiment are an example configuration of a wireless-connection unit. Furthermore, the wireless packet transmitting/receiving unit 11B in the second embodiment is an example packet transmitting/receiving unit.

What is claimed is:

1. A communication device that relays packets in a communication system, the communication device comprising:
a packet transmitting/receiving unit that transmits/receives packets;
a use-rate detecting unit that detects a use rate of the packet transmitting/receiving unit;
a cooling fan that rotates at a rotation speed in accordance with a supplied output voltage value in order to cool the communication device;
a power source unit that supplies power to the cooling fan at a predetermined output voltage value; and
a voltage control unit that controls the output voltage value output by the power source unit based on a use rate of the packet transmitting/receiving unit detected by the use-rate detecting unit.

2. The communication device according to claim 1, wherein
the packet transmitting/receiving unit includes a wired-connection unit that is connected to a terminal of the communication system through a cable, and
the use-rate detecting unit detects a use rate of the packet transmitting/receiving unit in accordance with the number of terminals connected with the wired-connection unit and a connection speed with the terminal.

3. The communication device according to claim 1, wherein
the packet transmitting/receiving unit includes a wireless-connection unit that is wirelessly connected to a terminal of the communication system, and
the use-rate detecting unit detects a use rate of the packet transmitting/receiving unit in accordance with a use rate of a transmitter amplifier included in the wireless-connection unit.

4. The communication device according to claim 1, wherein
the cooling fan is detachable from the communication device,
the communication device further comprises a fan detecting unit detecting whether or not the cooling fan is attached to the communication device, and
when the fan detecting unit detects that no cooling fan is attached, the communication device restricts an operation of the packet transmitting/receiving unit.

5. The communication device according to claim 1, wherein the voltage control unit controls the output voltage value so that the higher the use rate of the packet transmitting/receiving unit detected by the use-rate detecting unit is, the faster the rotation speed of the cooling fan becomes.

6. A control method for a communication device which relays packets in a communication system and which includes a packet transmitting/receiving unit that transmits/receives packets, and a cooling fan that rotates at a rotation speed in accordance with a supplied output voltage value in order to cool the communication device, the control method comprising the steps of:
causing the packet transmitting/receiving unit to transmit/receive packets;
detecting a use rate of the packet transmitting/receiving unit; and
supplying power to the cooling fan at an output voltage value in accordance with the detected use rate.
